(19) United States
(12) Patent Application Publication
(10) Pub. No.: US 2016/0196619 A1
(43) Pub. Date: Jul. 7, 2016

(54) HOMOGENIZING TIME-BASED SENIORITY SIGNAL WITH TRANSITION-BASED SIGNAL

(71) Applicant: LinkedIn Corporation, Mountain View, CA (US)

(72) Inventors: Uri Merhav, Rehovot (IL); Vitaly Gordon, Mountain View, CA (US); Kin Fai Kan, Sunnyvale, CA (US)

(21) Appl. No.: 14/588,843

(22) Filed: Jan. 2, 2015

(51) Int. Cl. G06Q 50/00; G06Q 10/10; G06F 17/27

(52) U.S. Cl. CPC G06Q 50/01; G06F 17/277; G06Q 10/105

(57) ABSTRACT

A seniority standardization system may be configured to derive seniority values in the context of an on-line social network system. In order to determine a seniority rank of a given professional title, a seniority standardization system may leverage transition data, which is information that may be gleaned from a member profile with respect to the member's transition from one professional position to another. A seniority standardization system may also use time-based seniority signal. A time-based seniority value, which may be assigned to a particular professional title, is the amount of time that it typically takes to achieve a professional position represented by that particular professional title.

### TECHNICAL FIELD

This application relates to the technical fields of software and/or hardware technology and, in one example embodiment, to system and method to determine seniority weights for tokens utilizing time-based seniority signal and transition-based seniority signal.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to derive seniority values utilizing time-based seniority signal and transition-based seniority signal may be implemented;

FIG. 2 is block diagram of a system to derive seniority values utilizing time-based seniority signal and transition-based seniority signal, in accordance with one example embodiment;

FIG. 3 is a flow chart of a method to derive seniority values utilizing time-based seniority signal and transition-based seniority signal, in accordance with an example embodiment;

FIG. 4 is a flow chart of a method to determine seniority rank of a member in an on-line social network system, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to derive seniority values in the context of an on-line social network utilizing time-based seniority signal and transition-based seniority signal is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social network system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills. Information about a member's professional skills may be referred to as professional attributes. Professional attributes may be maintained in the on-line social network system and may be used in the member profiles to describe and/or highlight professional background of a member. Some examples of professional attributes (also referred to as merely attributes, for the purposes of this description) are strings representing professional skills that may be possessed by a member (e.g., “product management,” “patent prosecution,” “image processing,” etc.).

The profile of a member may also include information about the member's current and past employment, such as company names and professional titles, also referred to as job titles. An on-line social network system may store a great number of raw titles, as members (also referred to as users) may be permitted to input any description into a field (e.g., referred to as a job title field) allocated in their respective member profiles for data that is meant to describe their jobs. A title string that appears in the job title field in a member profile may include words indicative of various characteristics associated with the job of the member represented by the profile. Professional titles that appear in member profiles are not always descriptive enough to permit a clear assessment of the respective member's professional seniority. For example, the title “Senior Vice President of Products and User Experience” may be treated as associated with seniority level given to positions that deal with user experience, which are typically low seniority positions, while, in fact, this title may carry significant seniority at a particular company or in a particular industry. Thus, it may be beneficial to have a technique for automatically determining the rank or seniority of a member's professional position, based on the title string that is provided in the member's profile. A system to derive seniority values in the context of an on-line social network system may be termed a seniority standardization system.

In order to determine a seniority rank of a given professional title, a seniority standardization system, in one example embodiment, may leverage so-called transition data, which is information that may be gleaned from a member profile with respect to the same member's transition from one professional position to another. Transition data, for the purposes of this description, may be in the form of pairs of title strings, where each pair is also associated with a so-called label that indicates the direction of a transition signified by the pair. A pair of title strings and its associated label may be termed a transition pair. For example, a transition pair may include two title strings (e.g., “software developer” and “senior software developer”) and a label indicating that the chronological direction associated with the professional transition of the associated member is from a position identified by the title string “software developer” to the position identified by the title string “senior software developer.” Thus, a label in an associated transition pair indicates that one title string in the transition pair may be treated as being indicative of a greater seniority rank than the other one title string in the transition pair.

Transition data items having two title strings that are from the same member profile, and thus represent transition of a particular member from one professional position to another, may be referred to as a transition-based signal. Another type of signal that is related to seniority and that can be obtained from profiles in an on-line social network system is a so-called time-based seniority signal. A time-based seniority value, which may be assigned to a particular professional title, is the amount of time (e.g., the number of years) that it typically takes to achieve a professional position represented by that particular professional title. In a corpus of title strings, which may be standardized (also referred as canonical) titles, each title string may be associated with a respective time-based seniority signal. These two signals, transition-based and time-based, both carry important information that relates to seniority level of a member represented by a profile in an on-line social network system. While these two signals are fundamentally different (the transition-based seniority signal being presented in a pairwise fashion and the time-based seniority signal being presented as a value associated with an individual title), it may be beneficial to establish an automatic learning method that draws information from both of these signals at the same time. According to one example embodiment, the time-based seniority signal may be converted into a transition signal using a procedure as described below.

In operation, a seniority standardization system first obtains data representing transitions between jobs that the members of the on-line social network system have reported via their respective profiles. As mentioned above, an item of transition data typically includes two title strings representing respective two professional positions of the same member of an on-line social network system. A seniority standardization system may then augment the obtained transition data with one or more supplemental transition items, where the two title strings in the same supplemental transition item are obtained from two different member profiles and where one of the string titles is selected based on how infrequently it appears in all transaction data and where the other title string may be selected randomly or based on a predetermined criteria. Thus, a seniority standardization system identifies those job titles that weren't involved in many transitions reported by members of an on-line social network system, and would therefore benefit from the associated time-based seniority signal. Based on respective time-based seniority values of the two title strings in a supplemental transition item, a seniority standardization system infers a label that indicates that one title string in the transition pair is indicative of a greater seniority rank than the other one title string in the transition pair. The title string that is assigned a greater time-based seniority value is considered to be indicative of greater seniority than the title string that is assigned a lower time-based seniority value. The importance of the supplemental transition item may be weighted by some measure of confidence level in the time-based seniority signal, based on the observed time-based seniority signal variance, and the size of the time-based seniority signal difference.

Statistical tests may be applied to determine validity of every supplemental transition item. As a naïve example, let's call the average time that takes to achieve the professional position represented by the title string “software engineer” TBS1, and the average time it takes to achieve the professional position represented by the title string “graphic designer” TBS2. A seniority standardization system may be configured to measure the variance of TBS1 and TBS2, and perform a statistical test (e.g., p-test) to determine whether the title string “software engineer” has a higher ranking than the title string “graphic designer” in a statically significant way, and weight it accordingly.

A time-based seniority signal can also be weight with respect to the transition-based signal, which may be achieved by performing a normalization procedure. Denoting the weights of supplemental transitions as w, and the weights of originally-obtained transitions as \tilde{w}ᵢ, a seniority standardization system may choose a scaling constant A such that

$${\sum }_{i} {( {Aw}_{i} )}^{2} = α {\sum }_{i} {( {\tilde{w}}_{i} )}^{2} .$$

Setting α=1 normalizes the two signals so that they weigh similarly in some sense; and letting α tend either towards 0 or to infinity favors either the time-based seniority signal or transition-based seniority signal.

The process of augmenting transition data with supplemental transition items generated using time-based seniority information may ultimately result in a homogenous space of transitions that incorporates both time-based seniority signal data and transition-based knowledge. The resulting dataset —transition data augmented with the supplemental transition items—may be subsequently used to learn seniority levels, e.g., using regularized linear model—or any other Learn-To-Rank model that is known in prior art.

In one embodiment, a seniority standardization system employs a seniority standardization model (also termed merely a model for the purposes of this description) constructed to examine transition data from the member profiles maintained by the on-line social network and to determine how various words and phrases that may appear in the title strings affect professional seniority of a member represented by a profile that identifies the member as having a particular title. For example, the model may identify the word “senior” as having a significant positive effect on the seniority associated with the title string because in the majority of transition pairs where the word “senior” appears in one of the title strings, that title string is associated with a more recent position. Or, the model may identify the word “associate” as having a negative effect on the seniority associated with the title string because in the majority of transition pairs, where the word “senior” appears in one of the title strings, that title string is associated with a less recent position.

A seniority standardization system analyzes the transition data, which may be augmented with supplemental transition items, as described above, and identifies in the transition data so-called tokens that, alone or in combination, may constitute a title string. A token is word or a phrase that may be included in a title string that is present in a member profile. Thus, the phrases “senior,” “associate.” “vice president,” “director,” etc., may all be considered as tokens for the purposes of this description. For example, from the title string “senior vice president” the model may generate the following tokens: “senior,” “vice,” “president,” “senior vice,” and “vice president.” In one embodiment, the tokens of lengths greater than 1 are formed from words that appear consecutively in the title string. The seniority standardization model may then analyze the transition data and the identified tokens to generate a weight for each token, utilizing a logistic regression, such as, e.g., “Lasso Regularization of Generalized Linear Models.” The weight for a token indicates a contribution of the token to a seniority rank of a title string that includes the token. In some embodiments, a seniority standardization system identifies only those tokens that correspond to a standardized title or a seniority modifier. An on-line social network system may store respective dictionaries of standardized (also referred as canonical) titles and of seniority modifier terms. Some example approaches to generating a dictionary of canonical terms and a dictionary of seniority modifiers are described further below.

The seniority rank of a title string may be determined as a sum of the weights of the tokens that constitute the title string. For example, if the weight assigned to the token “senior” is 5 and the weight assigned to the token “director” is 8, the seniority rank of the title string “Senior Director” may be calculated as the sum of the weight assigned to the token “senior” and the weight assigned to the token “director,” which adds up to 13. A token may also have a negative value. For example, if the weight assigned to the token “president” is 20 and the weight assigned to the token “vice” is (−5), the rank of the title string “Vice President” may be calculated as the sum of the weight assigned to the token “president” and the weight assigned to the token “vice,” which adds up to 15. A weight assigned to a token may also be a decimal number.

A seniority standardization model may utilize a plurality of rules. One of the rules employed by the model may be to infer that the more recent position in the employment history of a member is associated with a greater seniority, as compared to a less recent position. Another rule employed by the model may be to infer that position A has a greater seniority that position B, if the majority, if not all, transition pairs that include title strings A and B are associated with the label indicating that position A is chronologically more recent than position B. For example, the model may utilize a certain threshold (e.g., 80%) to establish relative seniority between two title strings. If the percentage of transition pairs—that include title strings A and B and have the associated labels indicating that position A is chronologically more recent than position B—is equal or greater than the threshold value, the title string representing position A is to be considered as associated with greater seniority than the title string representing position B.

In some embodiments, transition data used by a seniority standardization model may be selected based on the associated industry. For example, to determine seniority ranks for title strings that appear in the Internet industry, the transition data may be selected only from the member profiles associated with the Internet industry. To determine seniority ranks for title strings that appear in the banking industry, the transition data may be selected only from the member profiles associated with the banking industry. The model then determines the weights for various tokens with respect to that specific industry. Thus, the weight assigned to the token “principal” based on transition data associated with the Internet industry may be different from the weight assigned to the same token “principal” based on transition data associated with the banking industry.

In some embodiments, transition data used by a seniority standardization model may be selected based on the associated geographic location. For example, to determine seniority ranks for title strings that appear in member profiles representing members located in Europe, the transition data may be selected only from the member profiles indicating that the associated member or an employer referenced in the profile is located in Europe. The model then determines the weights for various tokens with respect to that specific geographic location. The tokens and their associated weights may be saved in a database and may be periodically updated to reflect changes in the universe of member profiles in the on-line social network system.

The system to infer professional seniority of a member may be configured to associate profiles in the on-line social network system with respective seniority ranks, based on the title string found in a given profile that represents the most recent professional position of the associated member. In one embodiment, if the title string found in a given profile that represents the most recent professional position of the associated member is obscure in a sense that no sufficient transition data is available with respect to that title string, the model may determine the seniority rank to be assigned to the profile based on a title string in the profile that represents a previously-held position. Examples of obscure title strings may include, e.g., “director of beta science” or “head of query understanding.”

A seniority rank associated with a member profile may be used to match that profile with various job postings in the on-line social network. It may also be used by hiring managers that are looking to match professionals with available jobs. A seniority rank value may be included into a search query requested within the on-line social network system. Seniority rank information may also be used in ad targeting, such that, e.g., certain ads may be presented to members associated with a certain range of seniority ranks. Also, the charge per impression for an ad may be different based on the seniority rank of a member who is the target of the ad. For example, the charge per impression for an ad may be greater when it is presented on a news feed page of a member assigned a greater seniority rank.

As mentioned above, an on-line social network system may store a dictionary of canonical titles. A system for processing title strings that appear in member profiles in an on-line social network system may be termed a title standardization system. The process of deriving a canonical title from a subject string (either from a raw title string or from a core title) may involve calculating various conditional probabilities with respect to words that appear in the subject string. Conditional probabilities may be calculated with respect to a corpus of title strings (that may include all or a subset of raw title strings stored in the on-line social network system) and may include values, such as a value reflecting the frequency of occurrence of two words together, a value reflecting the frequency with which a phrase occurs in the corpus of title strings, probability that a certain phrase is a complete stand-alone job title, etc. For example, if a subject string is “a software rocket engineer,” a title standardization system may be able to recognize, based on the calculated conditional probabilities, that the word “rocket” almost never appears after the word “software,” while the word “engineer” appears very frequently after the word “software” in the title strings stored in the on-line social network system. Based on this information, the title standardization system may infer that the word “rocket” may be omitted, leaving the phrase “software engineer” to be the selected canonical title. A system for processing title strings that appear in member profiles in an on-line social network system may be termed a title standardization system.

In operation, a title standardization system examines a raw title string to identify so-called parts of title, also referred to as a canonical triplet, where each part of title may be related to a particular type of information. For example, a raw title string may be parsed into a prefix/core/suffix triplet, where the core part of the title is related to the job function, while the prefix and the suffix may be related to other characteristics of a professional position, such as seniority, geographic location information, etc. An example representation that comprises these three parts—a prefix, a core, and a suffix—of a raw title string “executive SVP of human resources @Yahoo.com” obtained from a subject profile is shown below as Example (1).

Example (1)

[PREFIX: executive senior] [Core: vp of hr yahoo.com] [SUFFIX: empty]

Another example, the representation that comprises these three parts of a raw title string “senior data scientist at yahoo.com” is shown below as Example (2).

Example (2)

[PREFIX: senior] [Core: data scientist at yahoo.com] [SUFFIX: empty]

It will be noted that either or both of the prefix and the suffix parts of title may be represented by an empty or a null string. The processing of a raw title string my include applying hardcoded expansion rules to remove capitalization and expand common acronyms, as well as to identify prefix and suffix modifier words at the start and at the end of the title string respectively. The prefix and suffix modifier words may be identified based on examining entries in the previously compiled dictionary of such modifier words. The string associated with the core part of a raw title string, a core title, may be analyzed to identify a canonical title, as described below.

In processing of a subject title string to identify a corresponding canonical job title, a title standardization system may utilize a so-called n-gram language model, which may be constructed to evaluate respective frequencies of occurrence and co-occurrence, as well as conditional probabilities for n-grams that appear in a subject title. Canonicalization of a given subject title may involve extracting n-grams from the subject title and, for every extracted n-gram, calculating frequency of occurrence value and one or more conditional probabilities with respect to a corpus of title strings selected from title strings stored in the on-line social network system. An n-gram will be understood as a set of n items from a given sequence of text.

An n-gram language model may be utilized to learn that a phrase, such as “VP of Engineering” is often a complete phrase, whereas “VP of” is almost never a complete phrase. In other words, an n-gram language model may provide an objective way to ascertain what might be a reasonable job title, where a reasonable job title is a title string that often appears in the dataset of title strings as a complete phrase and rarely appears as an incomplete phrase and is also ubiquitous to some extent. In one embodiment, an n-gram language model may be configured to reject those n-grams that do not appear often enough in the dataset of title strings. With reference to the Example (1) above, some of the n-grams extracted from the core title identified for the subject profile (“vp of hr yahoo.com”) include strings “vp of,” “hr yahoo.com,” and “vp of hr.”

In one embodiment, the frequency of occurrence value for an n-gram reflects the frequency, with which the n-gram appears in the learning corpus of job titles that are stored in member profiles associated with the same industry as an industry associated with the subject profile. An n-gram language model may calculate conditional probability of the subject n-gram being followed by the <end> token. The <end> token may be used to indicate the end of the subject core title. For instance, this conditional probability value may indicate what percentage of the time, of all the times the term “vp of” appears in the corpus, it is followed by some other word, as opposed to being followed by the <end> token. Another conditional probability value may indicate probability of the n-gram being preceded by the <start> token (that indicates the beginning of the subject core title) and also being followed by the <end> token. Based on the calculated respective frequencies of occurrence and the conditional probabilities, the model may select an n-gram that is deemed to provide the best description of the member's job and identify the selected n-gram as a canonical title that corresponds to the raw title string.

In one example embodiment, each n-gram extracted from a subject title string may be assigned scores corresponding to results of comparisons of calculated respective frequencies of occurrence and the conditional probabilities with respective thresholds, and the model may select the highest-scoring n-gram as the canonical title. Provided two or more n-grams have the same score, the longest n-gram may be selected as the canonical title. Alternatively, the selection of an n-gram may be based on one of the scores, while the other scores may be used to exclude an n-gram from the consideration for the canonical title. With reference to the Example (1) above, the string “vp of hr” would be selected as the canonical title that corresponds to the subject title string. The canonical title determined as the result of applying an n-gram language model to the raw title string may be then associated with the subject member profile, and the association may be stored in a database for future use.

Thus determined canonical title may be also included into a dictionary of canonical titles, which may be stored in a database. As mentioned above, an entry in the dictionary of canonical titles may include a title string representing a particular canonical title and also a seniority rank indicating seniority or rank of the professional position represented by the title string. Respective seniority ranks for the canonical titles may be assigned manually or automatically, e.g., utilizing transition data from member profiles stored in an on-line social network system.

As explained above, the seniority rank associated with a title string may be determined as a sum of the seniority rank assigned to the corresponding canonical title and the respective seniority ranks of one or more seniority modifiers that may be present in the subject title string. A seniority modifier is a phrase comprising one or more words that have been identified as being indicative of seniority if included in a title string. Seniority modifiers in a subject title strings may be identified by consulting a dictionary of seniority modifiers. According to one embodiment, a dictionary of modifier phrases, including seniority modifiers, may be generated using an example approach described below. Modifier terms are those phrases in a title string that have been identified as indicative of a certain aspect related to the job of the associated member. Modifier phrases that are indicative of the job seniority are termed seniority modifiers. Example seniority modifiers are phrases like “senior,” “assistant,” “intern,” etc.

According to one example embodiment, in order to identify seniority modifiers in the title strings provided in member profiles in an on-line social network system, a title standardization system may leverage transition data. For every transition pair extracted from a sample set of member profiles, a title standardization system determines whether it conforms to a stable pattern across the sample set of member profiles with respect to a potential modifier phrase. Such pattern may indicate that a position represented by title string “X” is typically followed by a position represented by title string “Y X” (e.g., the results of examination of transition data extracted from the sample set of data profiles indicates that a position represented by the title “data scientist” is typically followed by a position represented by the title “senior data scientist”). Another pattern may indicate that a position represented by title string “YX” is typically followed by a position represented by title string “X” (e.g., the results of examination of transition data extracted from the sample set of data profiles indicates that a position represented by the title “assistant manager” is typically followed by a position represented by the title “manager”). Yet another pattern may indicate that a position represented by title string “XY” is typically followed by a position represented by title string “X” (e.g., the results of examination of transition data extracted from the sample set of data profiles indicates that a position represented by the title “data scientist intern” is typically followed by a position represented by the title “data scientist”). Yet another pattern may indicate that a position represented by title string “XY” is typically followed by a position represented by title string “X” (e.g., the results of examination of transition data extracted from the sample set of data profiles indicates that a position represented by the title “data scientist intern” is typically followed by a position represented by the title “data scientist”).

In one embodiment, in order to determine whether a transition pair conforms to a stable pattern across the sample set of member profiles, a title standardization system may utilize a model that may be constructed and applied to the member profiles. One of the rules employed by the model may be to infer that a certain transition pattern is a stable pattern if more than or equal to a certain percentage (e.g., 80%) of all transition pairs that are being examined that include a first title string and a second title string are characterized by a certain pattern: e.g., a potential modifier phrase is present in the first title string and is lacking from the second title string or vice versa.

If a transition pair comprising a first title string and a second title string was determined to be conforming to a stable pattern, a phrase that is included in the first title string and is lacking from the second title string is identified as a modifier phrase and stored in a dictionary for future use. A modifier phrase, also referred to as merely a modifier, may include one or more words. A modifier that appears at the beginning of a title string or before the phrase that is included in both title strings in a transition pair may be referred to as a prefix. A modifier that appears at the end of a title string or after the phrase that is included in both title strings in a transition pair may be referred to as a suffix.

A title standardization system may determine that a modifier relates to seniority if more than or equal to a certain percentage of all transition pairs that are being examined that include the modifier are characterized by a pattern, where a position represented by the first title string that includes the modifier is associated with a time period that is less recent than the position represented by the second title string that lacks the modifier, or vice versa. In other words, a title standardization system may determine that, for example, the word “senior” is typically added to a job title that represents a more recent position (people move up in ranks), but is almost never removed from a job title that represents an earlier position. Thus it may be inferred that the word “senior” is indicative of seniority. Similarly, the word “intern” is typically removed from a job title that represents a less recent position, but is almost never added to a job title that represents later position. Some words, like “general,” may be determined to be indicative of seniority consistently in some industries but not so in others. For example the job title “general manager” may signify a more senior position than the job title “manager,” while the job title “general nurse” may not indicate increased seniority as compared to the job title “nurse.”

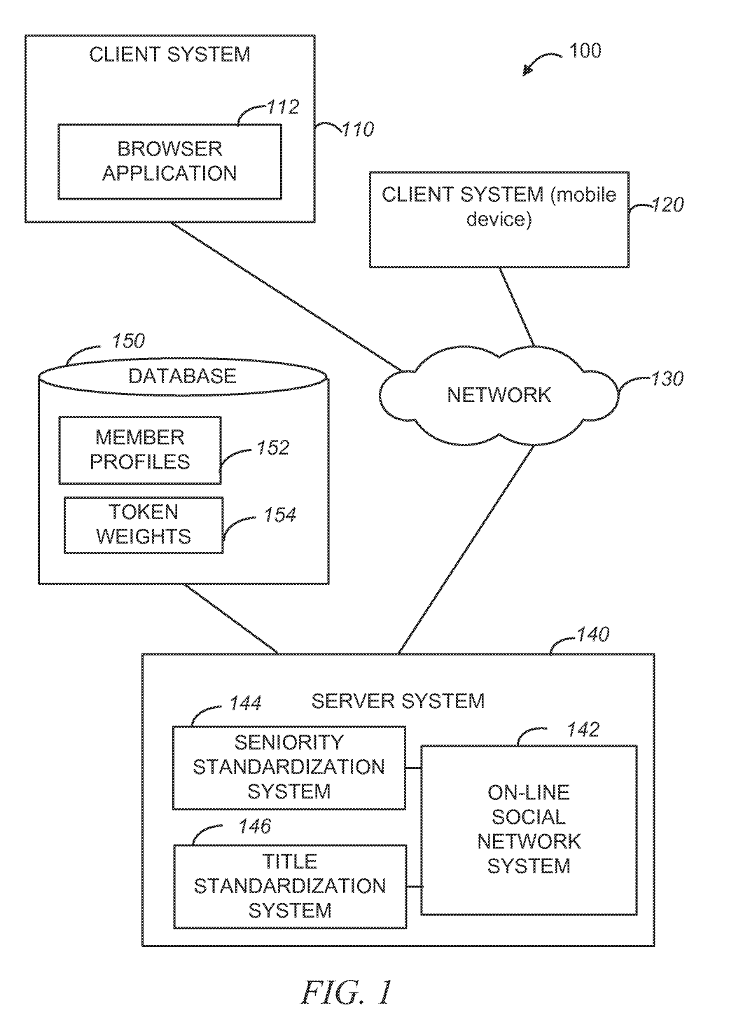

An example method and system to derive seniority values in the context of an on-line social network system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a seniority standardization system 144, which is a system to derive seniority values in the context of an on-line social network system. In one embodiment, the seniority standardization system 144 leverages transition data, which is information that may be gleaned from a member profile with respect to the same member's transition from one professional position to another, together with time-based seniority signal. As explained above, the seniority standardization system 144 obtains data representing transitions between jobs that the members of the on-line social network system 142 have reported via their respective profiles and augments the obtained transition data with one or more supplemental transition items, where the two title strings in the same supplemental transition item are obtained from two different member profiles and where one of the string titles is selected based on how infrequently it appears in all transaction data and where the other title string may be selected randomly or based on a predetermined criteria. The seniority standardization system 144 analyses the augmented transition data to derive weights for tokens that are present in the title strings of the transition data. These weights may be used later in calculating seniority ranks for title strings. The seniority standardization system 144 may store tokens and their associated weights as token weights 154 and store seniority ranks determined for title strings as associated with respective member profiles. For example, a seniority rank calculated for a particular title string may be stored as associated with a member profile, in which that particular title string represents the current professional position of the associated member. The seniority standardization system 144 may periodically update the token weights 154.

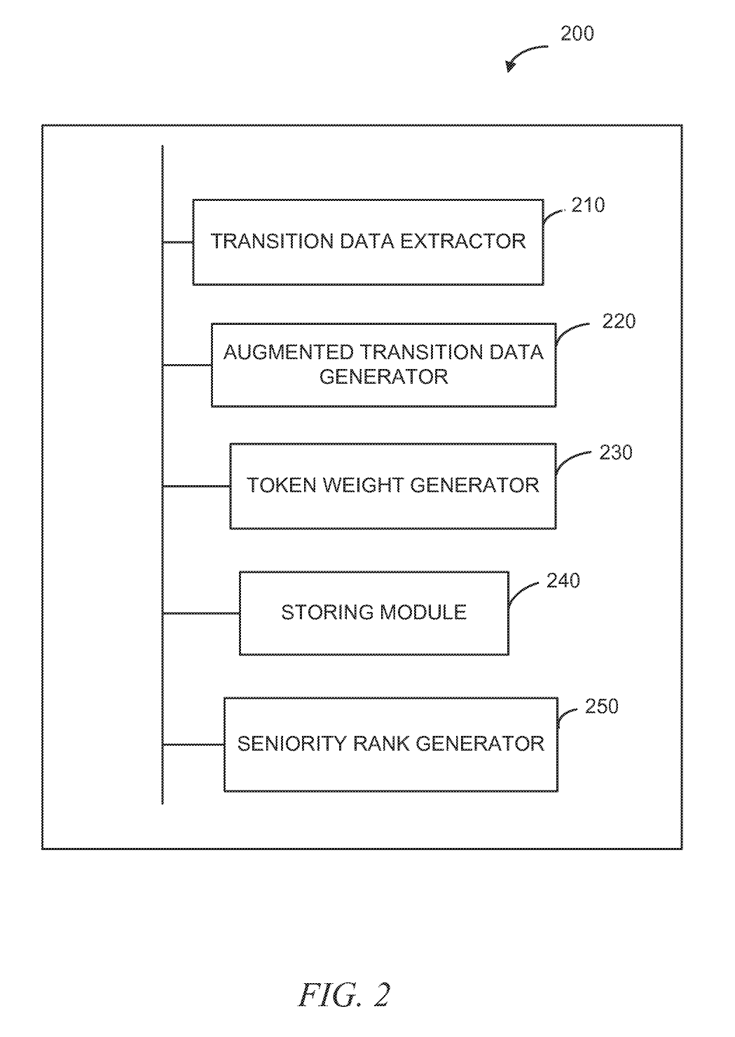

The server system 140 may also host a title standardization system 146, which is a system for processing title strings that appear in member profiles in an on-line social network system 142. The title standardization system 146 may be configured to analyze raw title strings included in the member profiles 152 and derive canonical titles from these raw title strings. Canonical titles may be determined by applying an n-gram language model to the raw title strings. Canonical titles may be then associated with respective member profiles, and the association may be stored in the database 150 for future use. As described above, the title standardization system 156 examines a raw title string to identify so-called parts of title, also referred to as a canonical triplet, where each part of title may be related to a particular type of information. In one embodiment, transition data analyzed by the seniority standardization system 144 may include title strings represented as canonical triplets. The title standardization system 146 may also be configured to identify seniority modifiers in the title strings provided in the member profiles 152, e.g., utilizing transition data, as described above. An example system for deriving seniority values in the context of an on-line social network system, which may utilize one of or both the seniority standardization system 144 and the title standardization system 142 is illustrated in FIG. 2.

FIG. 2 is a block diagram of a system 200 for deriving seniority values in the context of the on-line social network system 142 of FIG. 1. As shown in FIG. 2, the system 200 includes a transition data extractor 210, an augmented transition data generator 220, a token weight generator 230, and a storing module 240. The transition data extractor 210 may be configured to extract transition data, from a set of member profiles maintained in the on-line social network system 142 of FIG. 1. An item of the transition data comprises a first title string associated with a first time period and a second title string associated with a second time period, and a label, where the label indicates that the second title string has a greater seniority weight than the first title string. The extracted transition data is associated with a corpus of title strings, where a title string from the corpus of title strings represents a professional position of a member represented by a member profile maintained in the on-line social network system 142.

The augmented transition data generator 220 may be configured to identify an infrequent title from the corpus of title strings, select a further title from the corpus of title strings, determine that the time-based seniority value of the further title is greater than the time-based seniority value of the infrequent title, and generate augmented transition data. The augmented transition data is generated by adding to the extracted transition data one or more new items. An example of such new item is a supplemental transition item that comprises the infrequent title, the further title and a label indicating that the further title has a greater seniority rank than the infrequent title. The augmented transition data generator 220 determines that a title is an infrequent title if it appears in less than a certain percentage of titles present in the extracted transition data. The time-based seniority values indicating respective numbers of years of professional experience associated with the infrequent title and the further title. The further title may be selected randomly or based on predetermined rules. The token weight generator 230 may be configured to derive, from the augmented transition data, respective weights for a plurality tokens extracted from title strings in the corpus of title strings. A weight for a token indicates a contribution of the token to a seniority rank of a title string that includes the token. The storing module 240 may be configured to store the derived weights in the database 150 of FIG. 1, as associated with respective tokens.

A token includes one or more words that appear consecutively in a title string. The token weight generator 230 may be configured to derive weights only for those tokens that correspond to canonical titles and/or seniority modifiers. A seniority modifier is a phrase comprising one or more words that have been identified as being indicative of seniority if included in a title string.

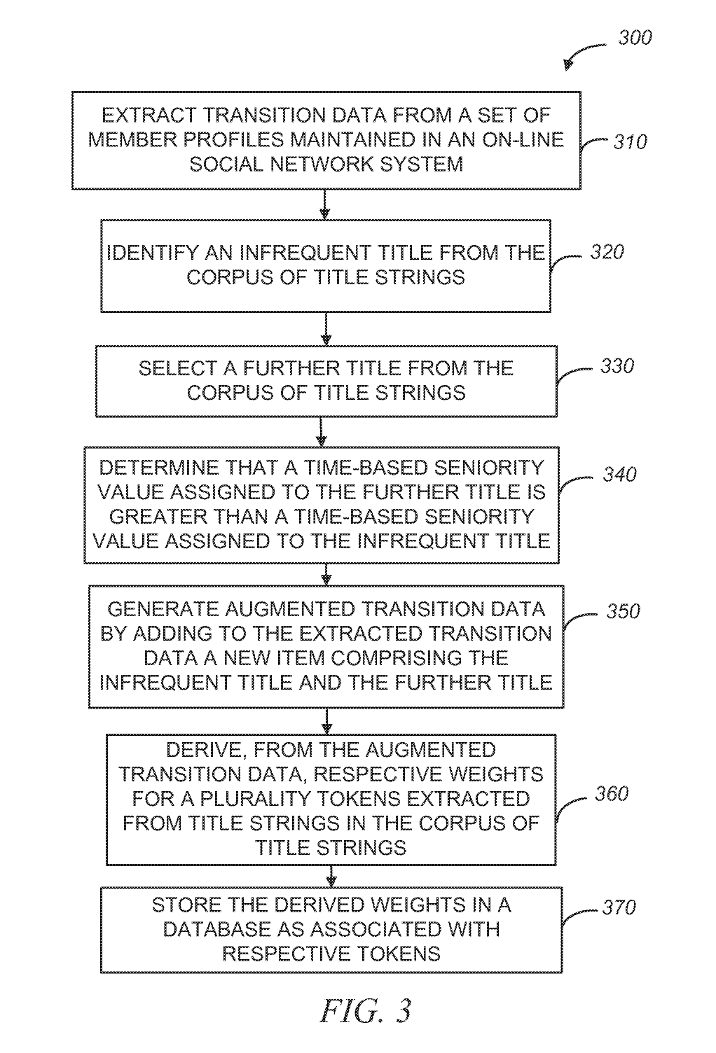

Also shown in FIG. 2 is a seniority rank generator 250. The seniority rank generator 250 may be configured to access a title string in a profile from the member profiles, determine a seniority rank for the title string based on respective weights of tokens from the plurality of tokens stored in the database 150 that are present in the title string, and associate the determined seniority rank with a profile from the member profiles. The seniority rank generator 250 may be configured to determine that a title string comprises a token representing a canonical title corresponding to the title string and another token representing a seniority modifier included in the title string, and calculate a seniority rank of the title string as a sum of just a weight of the first token and a weight of the second token. Some operations performed by the system 200 may be described with reference to FIG. 3.

FIG. 3 is a flow chart of a method to determine seniority rank of a member in the on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the transition data extractor 210 of FIG. 2 extracts transition data from a set of member profiles maintained in the on-line social network system 142 of FIG. 1. An item of the transition data comprises a first title string associated with a first time period and a second title string associated with a second time period, and a label, where the label indicates that the second title string has a greater seniority weight than the first title string. The extracted transition data is associated with a corpus of title strings, where a title string from the corpus of title strings represents a professional position of a member represented by a member profile maintained in the on-line social network system 142. At operation 320, the augmented transition data generator 220 of FIG. 2 identifies an infrequent title from the corpus of title strings. At operation 330, the augmented transition data generator 220 selects a further title from the corpus of title strings and determines that the time-based seniority value of the further title is greater than the time-based seniority value of the infrequent title at operation 340. At operation 350, the augmented transition data generator 220 generates augmented transition data by adding to the extracted transition data one or more new items. An example of such new item is a supplemental transition item that comprises the infrequent title, the further title and a label indicating that the further title has a greater seniority rank than the infrequent title. At operation 360, the token weight generator 230 of FIG. 2 derives, from the augmented transition data, respective weights for a plurality tokens extracted from title strings in the corpus of title strings. A weight for a token indicates a contribution of the token to a seniority rank of a title string that includes the token. The storing module 240 stores the derived weights in the database 150 of FIG. 1, as associated with respective tokens, at operation 370.

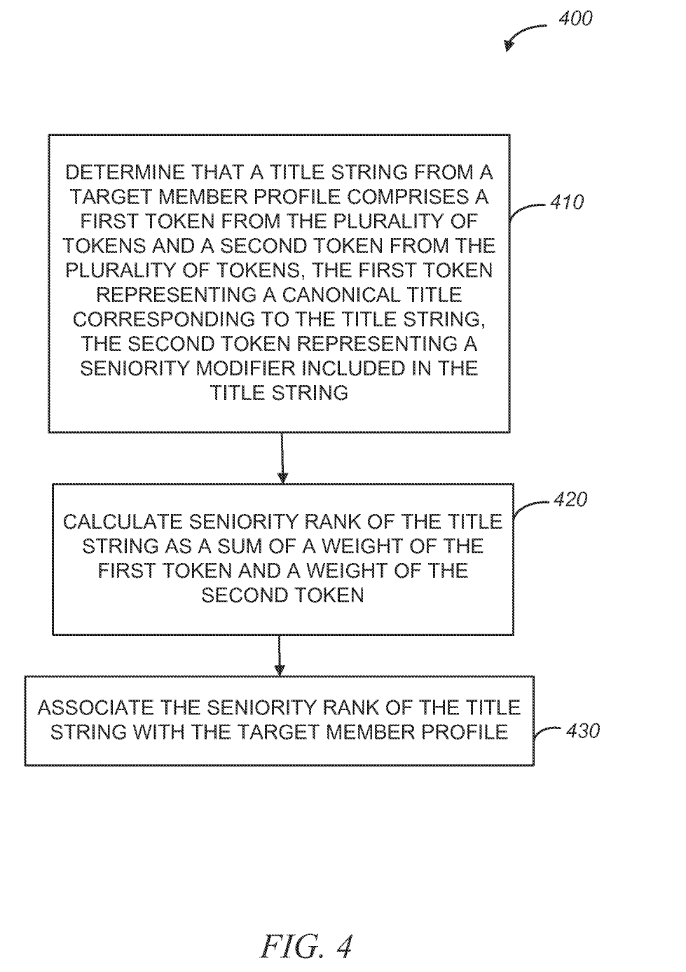

FIG. 4 is a flow chart of a method 400 to determine seniority rank of a member in an on-line social network system. The method 400 that may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

The method 400 commences at operation 410, when the seniority rank generator 250 of FIG. 2 accesses a title string in a target member profile and determines that the title string comprises a token representing a canonical title corresponding to the title string and another token representing a seniority modifier included in the title string. At operation 420, the seniority rank generator 250 calculates a seniority rank for the title string as a sum of a weight of the first token and a weight of the second token. At operation 430, the seniority rank generator 250 associates the determined seniority rank with the target member profile.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

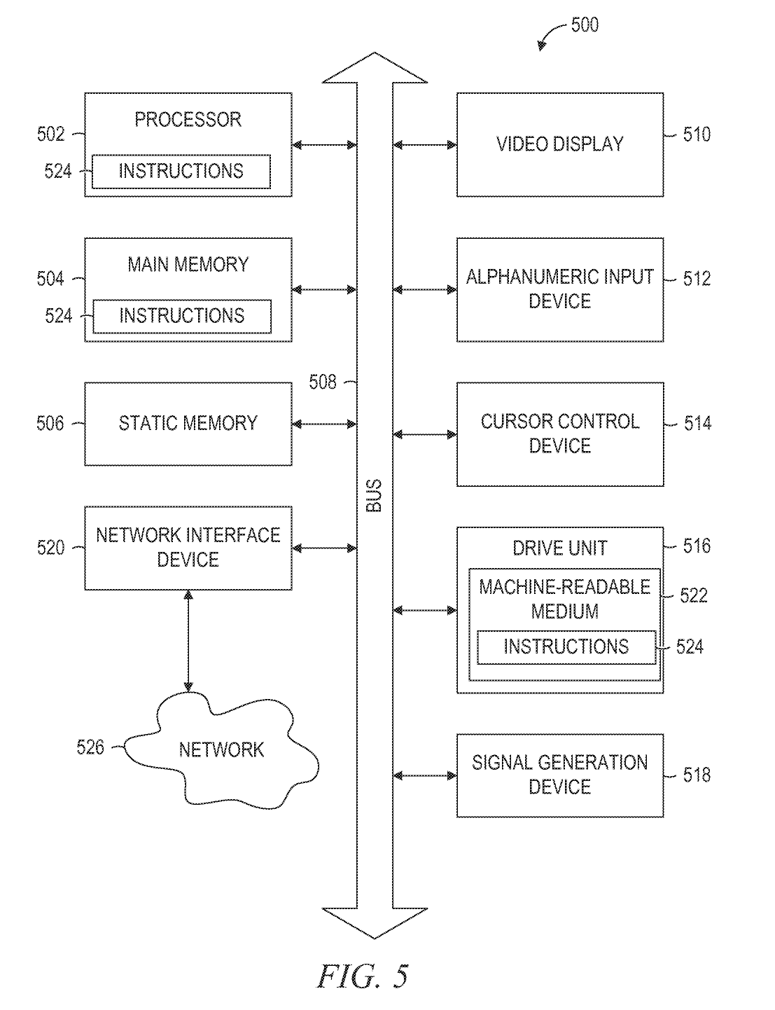

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to determine seniority weights for tokens utilizing time-based seniority signal and transition-based seniority signal has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
from a set of member profiles maintained in an on-line social network system, extracting transition data, an item of the transition data comprising a first title string associated with a first time period and a second title string associated with a second time period, and a label, the label indicating that the second title string has a greater seniority weight than the first title string, the extracted transition data associated with a corpus of title strings, a title string from the corpus of title strings representing a professional position of a member represented by a member profile from the set of member profiles;
identifying an infrequent title from the corpus of title strings, the infrequent title appearing in less than a certain percentage of titles present in the extracted transition data, the infrequent title associated with a first time-based seniority value, the first time-based seniority value indicating a number of years of professional experience associated with the infrequent title;
selecting a further title from the corpus of title strings, the further title associated with a second time-based seniority value, the second time-based seniority value indicating a number of years of professional experience associated with the second title;
determining that the second time-based seniority value is greater than the first time-based seniority value; and
using at least one processor, generating augmented transition data by adding to the extracted transition data one or more new items, an item from the one or more new items comprising the infrequent title, the further title and a label indicating that the further title has a greater seniority rank than the infrequent title;
from the augmented transition data, deriving respective weights for a plurality tokens extracted from title strings in the corpus of title strings, a weight for a token in the plurality of tokens indicating a contribution of the token to a seniority rank of a title string that includes the token; and
storing the derived weights in a database as associated with respective tokens from the plurality of tokens.

2. The method of claim 1, wherein a token from the plurality of tokens a token comprising one or more words that appear consecutively in a title string from the corpus of title strings.

3. The method of claim 2, wherein a token from a plurality of tokens is a canonical title corresponding to a title string in the corpus of the title strings.

4. The method of claim 2, wherein a token from a plurality of tokens is a seniority modifier from a title string in the corpus of the title strings.

5. The method of claim 2, comprising calculating a seniority rank of a title string from the corpus of title string as a sum of a weight of the first token and a weight of the second token.

6. The method of claim 2, wherein a weight for a token from the plurality of tokens is represented by a positive or negative number.

7. The method of claim 1, wherein title strings in the corpus of title strings are represented as canonical triplets, a canonical triplet comprising a prefix, a core, and a suffix, the core including a core string, the prefix including a non-empty or an empty string, the suffix including a non-empty or an empty string.

8. The method of claim 1, wherein the corpus of title strings is selected from those profiles from the on-line social network system that are associated with a particular industry.

9. The method of claim 1, comprising:
accessing a title string in a certain profile from the member profiles;
determining a seniority rank for the title string based on respective weights of tokens from the plurality of tokens stored in the database that are present in the title string; and
associating the seniority rank with the certain profile.

10. The method of claim 9, comprising:
accessing a job posting in the on-line social network system; and
based on the seniority rank associated with the certain profile, selecting the certain profile for presentation with the job posing.

11. A computer-implemented system comprising:
a transition data extractor, implemented using at least one processor, to extract, from a set of member profiles maintained in an on-line social network system, transition data, an item of the transition data comprising a first title string associated with a first time period and a second title string associated with a second time period, and a label, the label indicating that the second title string has a greater seniority weight than the first title string, the extracted transition data associated with a corpus of title strings, a title string from the corpus of title strings representing a professional position of a member represented by a member profile from the set of member profiles;
an augmented transition data generator, implemented using at least one processor, to:
identify an infrequent title from the corpus of title strings, the infrequent title appearing in less than a certain percentage of titles present in the extracted transition data, the infrequent title associated with a first time-based seniority value, the first time-based seniority value indicating a number of years of professional experience associated with the infrequent title,
select a further title from the corpus of title strings, the further title associated with a second time-based seniority value, the second time-based seniority value indicating a number of years of professional experience associated with the second title,
determine that the second time-based seniority value is greater than the first time-based seniority value, and
generate augmented transition data by adding to the extracted transition data one or more new items, an item from the one or more new items comprising the infrequent title, the further title and a label indicating that the further title has a greater seniority rank than the infrequent title;
a token weight generator, implemented using at least one processor, to derive, from the augmented transition data, respective weights for a plurality tokens extracted from title strings in the corpus of title strings, a weight for a token in the plurality of tokens indicating a contribution of the token to a seniority rank of a title string that includes the token; and
a storing module, implemented using at least one processor, to store the derived weights in a database as associated with respective tokens from the plurality of tokens.

12. The system of claim 11, wherein a token from the plurality of tokens a token comprising one or more words that appear consecutively in a title string from the corpus of title strings.

13. The system of claim 12, wherein a token from a plurality of tokens is a canonical title corresponding to a title string in the corpus of the title strings.

14. The system of claim 12, wherein a token from a plurality of tokens is a seniority modifier from a title string in the corpus of the title strings.

15. The system of claim 12, comprising a seniority rank generator, implemented using at least one processor, is to:
determine that a title string from the corpus of title strings comprises a first token from the plurality of tokens and a second token from the plurality of tokens, the first token representing a canonical title corresponding to the title string, the second token representing a seniority modifier included in the title string; and
calculate a seniority rank of the title string as a sum of a weight of the first token and a weight of the second token.

16. The system of claim 12, wherein a weight for a token from the plurality of tokens is represented by a positive or negative number.

17. The system of claim 11, wherein title strings in the corpus of title strings are represented as canonical triplets, a canonical triplet comprising a prefix, a core, and a suffix, the core including a core string, the prefix including a non-empty or an empty string, the suffix including a non-empty or an empty string.

18. The system of claim 11, wherein the corpus of title strings is selected from those profiles from the on-line social network system that are associated with a particular industry.

19. The system of claim 11, comprising a seniority rank generator, implemented using at least one processor, to:
access a title string in a profile from the member profiles;
determine a seniority rank for the title string based on respective weights of tokens from the plurality of tokens stored in the database that are present in the title string; and
associate the seniority rank with a profile from the member profiles.

20. A machine-readable non-transitory storage medium having instruction data executable by a machine to cause the machine to perform operations comprising:
from a set of member profiles maintained in an on-line social network system, extracting transition data, an item of the transition data comprising a first title string associated with a first time period and a second title string associated with a second time period, and a label, the label indicating that the second title string has a greater seniority weight than the first title string, the extracted transition data associated with a corpus of title strings, a title string from the corpus of title strings representing a professional position of a member represented by a member profile from the set of member profiles;
identifying an infrequent title from the corpus of title strings, the infrequent title appearing in less than a certain percentage of titles present in the extracted transition data, the infrequent title associated with a first time-based seniority value, the first time-based seniority value indicating a number of years of professional experience associated with the infrequent title;
selecting a further title from the corpus of title strings, the further title associated with a second time-based seniority value, the second time-based seniority value indicating a number of years of professional experience associated with the second title;
determining that the second time-based seniority value is greater than the first time-based seniority value; and
generating augmented transition data by adding to the extracted transition data one or more new items, an item from the one or more new items comprising the infrequent title, the further title and a label indicating that the further title has a greater seniority rank than the infrequent title;
from the augmented transition data, deriving respective weights for a plurality tokens extracted from title strings in the corpus of title strings, a weight for a token in the plurality of tokens indicating a contribution of the token to a seniority rank of a title string that includes the token; and
storing the derived weights in a database as associated with respective tokens from the plurality of tokens.
